(19) United States
(12) Patent Application Publication
(10) Pub. No.: US 2003/0038542 A1
(43) Pub. Date: Feb. 27, 2003

(54) Automatic braking system equipped in automobiles, cars, trucks..

(76) Inventor: Henri Duong, Whitehall, OH (US)

Correspondence Address: Henri Duong, 4627 Louise Avenue, Whitehall, OH, 43213, US

(21) Appl. No.: 09/943,930

(22) Filed: Aug. 27, 2001

(51) Int. Cl. B60T 8/32

(52) U.S. Cl. 303/193

(57) ABSTRACT

This Automatic Braking System is regarded as an invention to help every driver to brake one's car automatically due to unexpected event or event beyond driver's attention. It does not exist in automobile industry.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

It came from my imagination in the field of invention since traffic accident often happens where it costs human life daily even if one finds unsafely crossing the street. My imagination turns to develop step by step certain technical components related to my invention and I finally discover the structure of my invention by a system to brake a car automatically through modem technical operation.

### BRIEF SUMMARY OF THE INVENTION

Automatic braking systems are to be equipped in automobiles, cars, trucks. The advantages of the invention are to prevent killing, hurting human beings and damaging materials from traffic accidents.

This system composes of essential parts: Camera/radar or equivalent equipment, an electric motor, a triangle wheel or hexagon/multiple-angle wheel, an extension at the upper part of pedal, electric wires, a contact for driver use, a sonorous signal lamp and an alarm.

### BRIEF DESCRIPTION OF THE SEVERAL VIEWS OF THE DRAWING

“Not Applicable”

### DETAILED DESCRIPTION OF THE INVENTION

Camera or radar which has anti-frozen or heating system against snow is equipped in front of a car to view object or person who crosses a street accidentally at certain distance while a car is running, this camera or radar then sends information by electric wire to switch the motor on immediately to brake the car automatically by itself.

The motor runs by car electric power, its axis is equipped with a triangle wheel. Whenever the triangle wheel turns to its edge point pressing at the opposite side of the upper pedal, it is the moment it brakes the car as if a driver brakes his pedal at the lower part. The brake will be released while the flat part of the triangle wheel touches the upper pedal as a driver releases his foot off the pedal.

An extension of the upper part of the normal pedal is needed for the triangle wheel to brake the pedal at the opposite side. Driver may switch off the system by using a contact if necessary. Sonorous signal lamp rings while Automatic Braking System is turned off, it is to make sure the system is on when the car starts.

This is a new invention automatic braking system to be equipped in automobiles, cars, trucks that do not possess such a system.

Further proposal is to have small radar equipments equipped at both right & left side of a car with ability to sound the alarm once running cars extremely approach each other.

1. What I claim as my invention is: Automatic braking system equipped in automobiles, cars, trucks..

2. What I claim as my invention is: Automatic alarm system equipped in automobiles, cars, trucks . . . to avoid traffic accidents.
